(19) United States
(12) Patent Application Publication
(10) Pub. No.: US 2004/0081948 A1
(43) Pub. Date: Apr. 29, 2004

(54) Twin graded activity boards - restorative hand products

(76) Inventor: Rosemary E. Goodwin, Tucson, AZ (US)

Correspondence Address: Rosemary E. Goodwin, 3200 S. MANN AVE # Z, Tucson, AZ, 85730, US

(21) Appl. No.: 10/280,983

(22) Filed: Oct. 28, 2002

(51) Int. Cl. G09B 19/00

(52) U.S. Cl. 434/258

(57) ABSTRACT

A set of two graded activity boards designed for therapeutic training that elicits motor function. The system, which is called, Twin Graded Activity boards includes two boards, the first is called a Clinical board, the therapist in clinic uses this board to introduce reach training to the patient. The second board is called a Take Home board and is used by the patient at home. The purpose of the system is to promote home therapy after hospital discharge. A system that can enable the patient to make permanent upper extremity changes by taking the same therapy he/she uses in clinic, home at discharge.

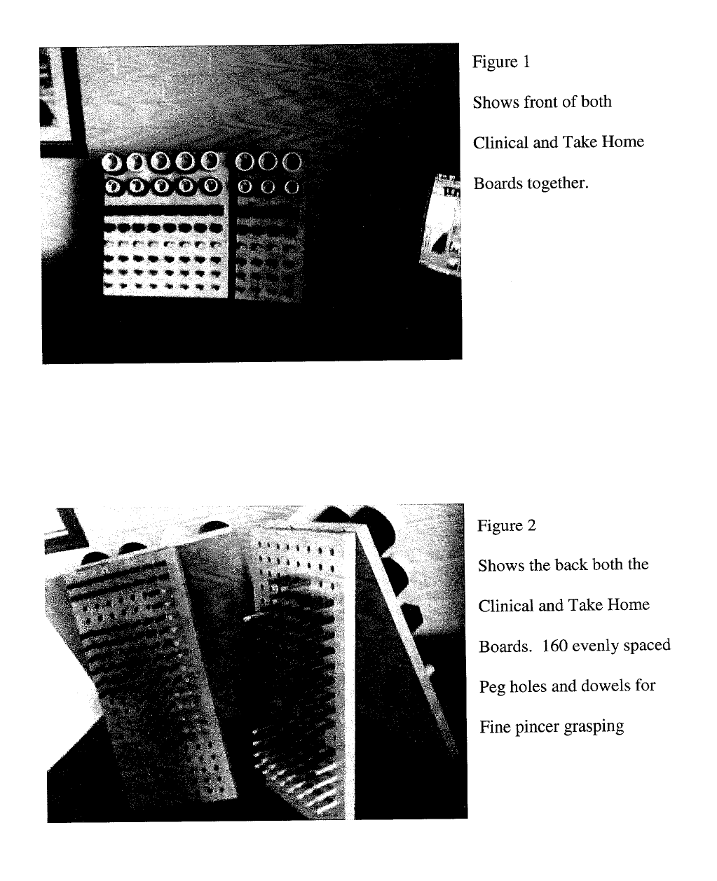

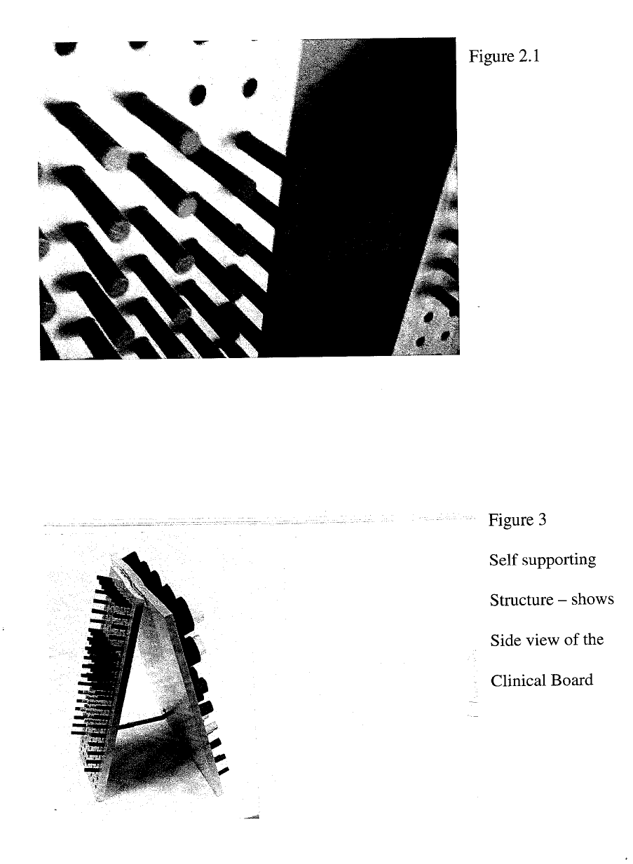

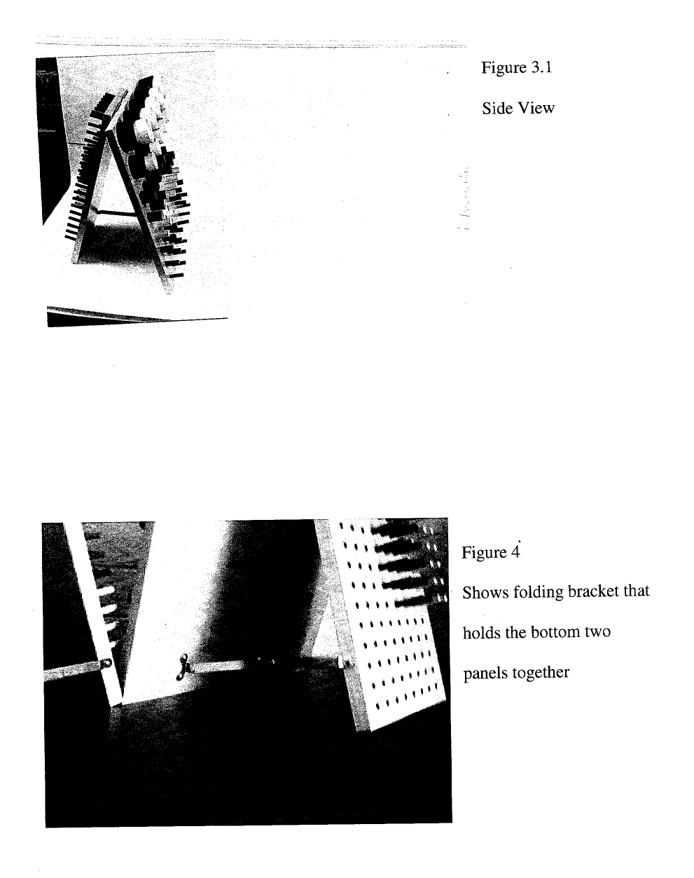

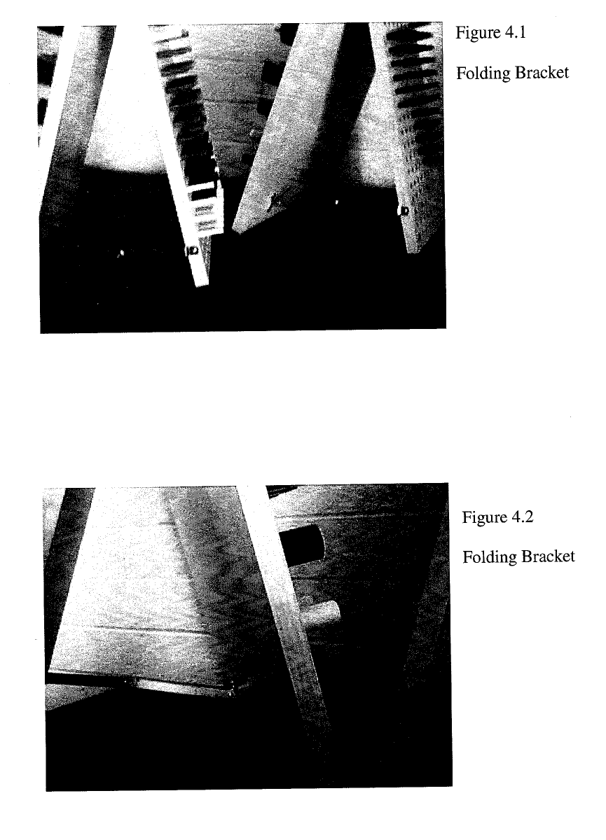

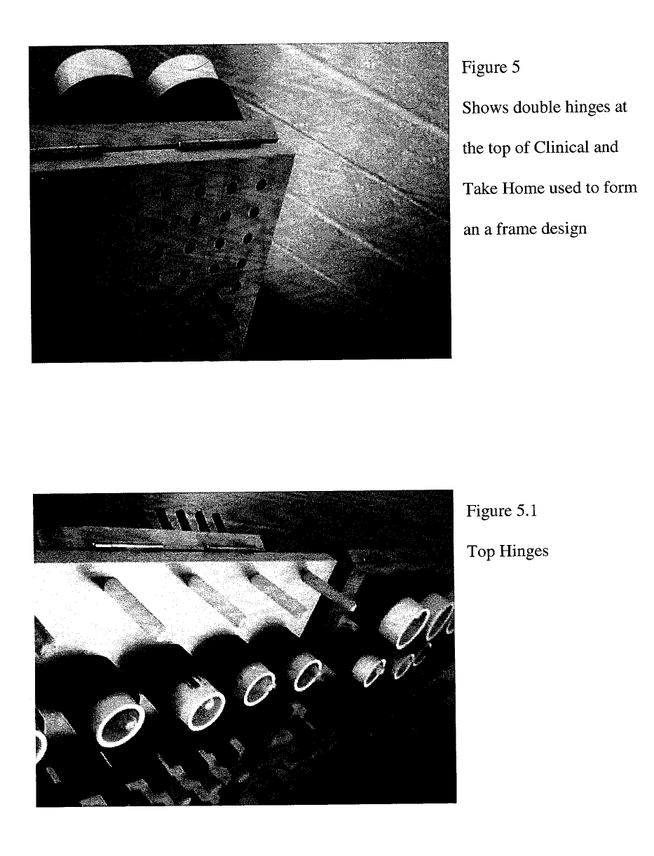

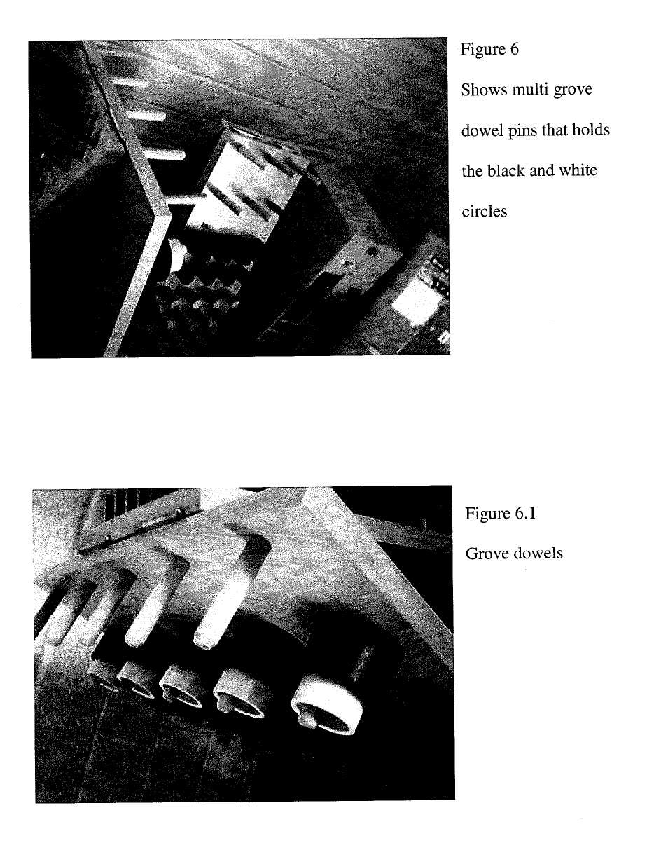

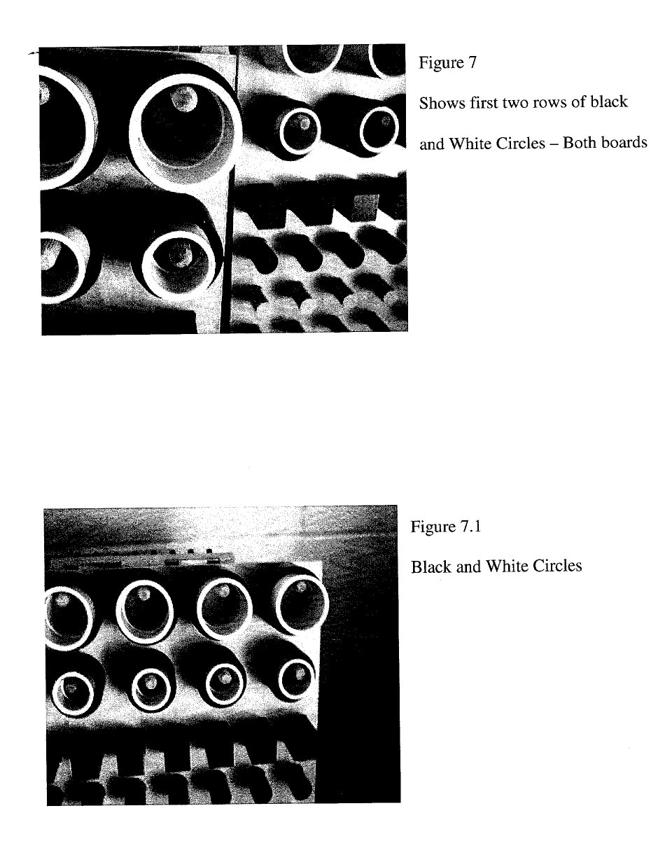

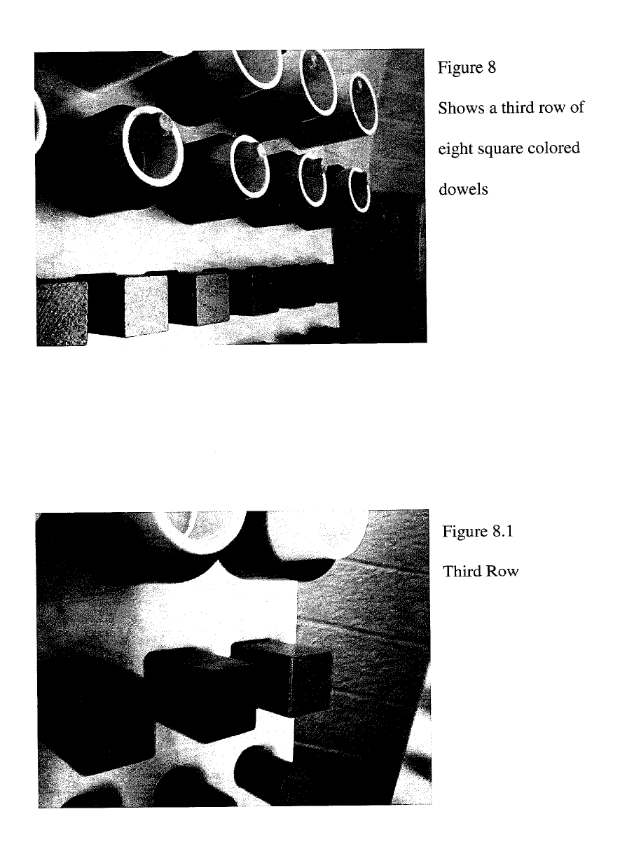

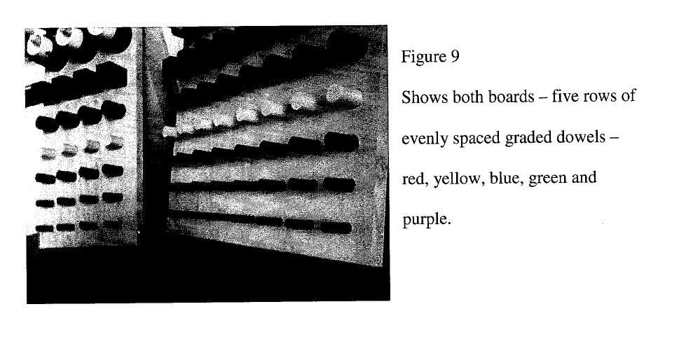

### CROSS-REFERENCE TO RELATED APPLICATIONS

N/A nonprovisional No. 60/114,122 lapsed

### STATEMENT REGARDING FEDERALLY SPONSORED RESEARCH OR DEVELOPMENT

N/A

### REFERENCE TO SEQUENCING LISTING, A TABLE OR COMPTER PROGRAM LISTING COMPACT DISC APPENDIX

N/A

### BACKGROUND OF INVENTION

The existing innovation corresponds to Graded Activity boards, principally, activity boards that offer a range of graded dowels for the purpose upper extremity reaching. The activity boards are suited for neurological disorders, CVA, head trauma, upper extremity injury and lower extremity injury (upper extremity reaching effects the lower part of the body). Expressly, A stand up, two panel, a frame, tabletop pegboard configuration of various size, tube like circles and dowels sizes. The term, twin conveys the use of two like boards, differing only in size.

Hospitals, acute care and medical centers use a wide variety of treatment tools for neurological hand deficits, in particular, deficits caused by stroke. These facilities habitually use a task-oriented approach. This means they use, activities of daily living as in grooming, feeding and dressing activities relating to daily living skills. These common modes of therapy have not been effective in rehabilitating neurological upper extremity insults because they are not repetitive in nature and do not tackle the core issue of neurological difficulty, which is resistant to half measures and demands repetitive training that is able to induce motor performance.

The challenge concerning all neurological injuries especially in the early stages of the insult is—the introduction of repetitive sensorimotor training—in the form of reach training. Repetitive execution of identical movements has been demonstrated to be crucial for recovery of hand/digit/arm function in a stroke/neurological patient.

Currently, in the medical market there are few effective tools that address upper extremity paralysis and essentially no therapies as the Twin boards that sends the patient home with the same therapy used in clinic

Moreover, medical facilities with time restraints, limit the kind and amount of therapy given. The usual regime of inpatient care involves bear basic training preparation for home. Take home plans in general often involve an extension of inpatient goals which include the therapies stated above—activities of daily living. This type of home therapy is insufficient for even marginal hand return and does not speak to depression caused by trauma. For the most part recovery is left up to the patient.

As explained earlier the medical market has few effective therapies to challenge the return of neurological hand deficits. With the exception of a therapy called constraint therapy (CT) that involves restraining the unaffected hand behind the patients back for a period of fourteen days, which forces the patient to use the affected hand. This kind of therapy (CT) may suggest how very resistant neurological injuries can be. A select few have access to this plan, as it is offered in a clinical setting and involves a long waiting period.

There is a desperate need for in clinic therapy tools that induce long lasting permanent changes in chronic upper extremity paralysis and for discharge plans that follow.

### BRIEF SUMMARY OF INVENTION

Twin Graded Activity Boards are designed to offer patient/therapist motivation with two twin boards, one, for the therapist in clinic (called Clinical Board-large), and another smaller version for the patient to use at home after discharge.

The therapist models clinical base instruction and than sends the patient home with the same therapy. One of the reasons for the two-board setup is to promote home programs in order for the patient to achieve full hand return. While motivating the therapist in the work place with use of a reliable therapy that will follow the patient home at discharge.

No graded pegboard on market symbolizes a concept of patient/therapist relationship nor suggests recovery with any number of boards or therapies. Graded Pegboards on the market, are simply pegboards with simple instructions for the use of fine motor skills.

The Twin boards is actually the first mode of physical structure on medical market that offers a concept of healing by using a system of like boards to induce repetitive movements and at the same time promote patient/therapist motivation.

What is claimed:

1) The process of rehabilitation of the neurological pathways particularly of persons subjected to neurological trauma effecting upper extremity as in stroke, comprising
A) Two, like (twin except for size) graded activity boards

1) First, a clinical or large model comprising
A) Two panels, forming an a frame with a front, back, upper and Lower side held together at the top by two cabinet hinges and at bottom by a table hindge, which allows the panels to fold
B) Said front panel having at the very top, two rows evenly spaced—pre clued dowel pins which hold, four sizes of black and white tube like rings.
Said panel having a third row of eight colored square blocks followed by five rows of evenly spaced graded colored dowels.
C) The back panel consists of one hundred sixty small 5/16^{th} Peg holes that hold same size dowels.

2) Second, the Take Home board or smaller version is exactly the same as the Clinical board except the front panel of the board is in proportion with the back of the board and has four less reaches on the two rows of black and white circles and half as many reaches with the square blocks and five rows of graded pegs

3) Grasp and release of the graded pegs eliciting reach training: and

4) Facilitating traumatized muscles or neurological pathways by manipulating and placing dowels and rings, thereby performing reach training or therapeutic function.
